(19) United States
(12) Patent Application Publication
(10) Pub. No.: US 2006/0097602 A1
(43) Pub. Date: May 11, 2006

(54) Electric motor and electric tool having the motor

(76) Inventors: Hideyuki Tanimoto, Hitachinaka-shi (JP); Shinichi Sakamoto, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/267,325

(22) Filed: Nov. 7, 2005

(30) Foreign Application Priority Data
Nov. 11, 2004 (JP) P2004-327239

(51) Int. Cl. H02K 1/12

(52) U.S. Cl. 310/254; 310/50; 310/45

(57) ABSTRACT

An electric motor designed for electric tools. The motor includes a stator core having a first stator core and a second stator core. The motor includes a first molded coil having a first coil covered entirely with a thermosetting resin that is electrically insulating and highly heat conductive. The motor also includes a second molded coil having a second coil covered entirely with the thermosetting resin. The first coil and the first stator core are integrally firmly fixed together by the thermosetting resin which is injected in a metal mold to cover the entire first coil after the first stator core and the first coil mounted on the first coil mounting portion are fixed to the metal mold. Similarly, the second coil and the second stator core are integrally firmly fixed together by the thermosetting resin.

### BACKGROUND OF THE INVENTION

1. Field of the Invention

The present invention relates to an electric motor having a coil that has been molded with resin and an electric tool provided with the electric motor.

2. Description of the Related Art

Japanese patent application publication No. HEI-8-9601 discloses an electric motor provided in an electric tool. In the motor, a coil and a portion of a stator core except a hollow area are covered with a resin. The electric motor is manufactured by pinching the stator core wound with the coil between an upper metal mold and a lower metal mold while inserting a center core made from elastic material provided on the lower metal mold into the hollow area, and pouring the resin into the upper and lower metal mold to cover the entire stator core and coil.

However, in the conventional electric motor described above, the shape of the metal mold is complicated and requires dimensional accuracy. Therefore, the metal mold is expensive. While the center core is inserted into and drew from the hollow area of the lower metal mold, the center core should not be come into contact with (or caught on) the stator core and the coil. Hence, the process of moving the center core requires much time period, thereby increasing production time of the electric motor.

### SUMMARY OF THE INVENTION

In view of the foregoing, it is an object of the present invention to provide an electric motor capable of reducing cost and production time, and to provide an electric tool provided with the electric motor.

In order to attain the above and other objects, the present invention provides an electric motor including a stator core, a first coil, a second coil, and a rotor.

The stator core has a first stator core including a first coil mounting portion, and a second stator core including a second coil mounting portion. The second stator core opposes the first stator core and is separated from the first stator core. A hollow area is provided in cooperation with the first stator core and the second stator core. The first coil is mounted in the first coil mounting portion. The second coil is mounted in the second coil mounting portion and opposes the first coil. The rotor is rotatably disposed in the hollow area and between the first coil and the second coil. The first coil and the first stator core are integrally firmly fixed to each other by a resin, and the second coil and the second stator core are integrally firmly fixed to each other by the resin.

In another aspect of the invention, there is provided an electric tool including a housing defining an outer frame and the above-described motor. The stator core of the motor is accommodated in and fixed to the housing.

### BRIEF DESCRIPTION OF THE DRAWINGS

The above and other objects, features, and advantages of the invention will become more apparent from reading the following description of the preferred embodiments taken in connection with the accompanying drawings in which:

FIG. 1 is a partial cross-sectional view showing a portable electric circular saw according to an embodiment of the present invention;

FIG. 2 is a perspective view of an electric motor according to the first embodiment;

FIG. 3 is a cross-sectional view of the motor in FIG. 2 taken in a plane orthogonal to the longitudinal direction of the motor;

FIG. 4 is a cross-sectional view showing a motor according to a second embodiment taken along the plane orthogonal to the longitudinal direction of the motor; and

FIG. 5 is a cross-sectional view showing a motor according to a third embodiment taken along the plane orthogonal to the longitudinal direction of the motor.

### DESCRIPTION OF THE PREFERRED EMBODIMENTS

A motor and an electric tool incorporating the motor according to preferred embodiments of the present invention will be described while referring to the accompanying drawings wherein like parts and components are designated by the same reference numerals to avoid duplicating description. The electric tool of the present invention is applied to a portable electric circular saw.

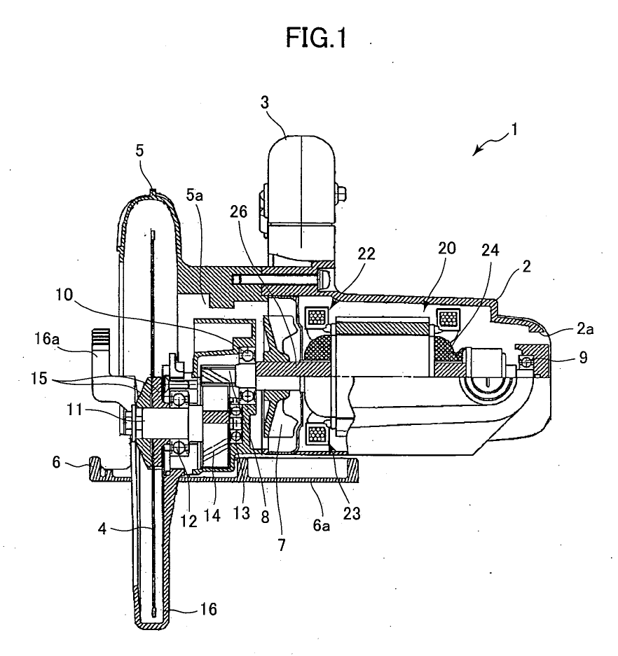

A motor and a portable electric circular saw 1 incorporating the motor according to a first embodiment of the present invention will be described with reference to FIGS. 1 through 3. As shown in FIG. 1, a portable electric circular saw 1 includes a housing 2 which internally supports and houses a motor 20, a handle 3, a saw blade 4, a saw cover 5, a base 6, and a fan 7. An air inlet 2a which connects the interior and exterior of the housing 2 is formed on one end of the housing 2. The handle 3 is provided integrally with the housing 2 or linked to the housing 2 as a separate member. A switch (not shown) is provided to the handle 3 to control the drive of the motor 20. The saw blade 4 is rotatable in only a normal rotation direction which can be cut a workpiece. The saw cover 5 is mounted to the housing 2, and is shaped so as to cover the upper half of the periphery of the saw blade 4.

A fan airflow outlet 5a is formed on the saw cover 5 to discharge the fan airflow (not shown). The base 6 is connected to the housing 2 via the saw cover 5 and has a bottom surface 6a that slides on the workpiece. The base 6 is formed with an opening (not shown) through which the saw blade 4 is projected downward beyond the bottom surface 6a. The motor 20 has a first molded coil 22, a second molded coil 23 and a rotor 24. The fan 7 is fixed to an output shaft 26 of the rotor 24 to cool the first molded coil 22, the second molded coil 23 and the rotor 24.

A pinion gear 8 is disposed at an end of the output shaft 26. The output shaft 26 and the pinion gear 8 are rotatably supported by first bearings 9 and 10. The first bearings 9 and 10 are provided on the air inlet 2a side of the housing 2 and on the saw cover 5, respectively. A drive shaft 11 extending parallel to the output shaft 26 is rotatably supported by second bearings 12 and 13 within the saw cover 5. The drive shaft 11 extends through the saw cover 5, and a gear 14 is coaxially fixed to the drive shaft 11. The gear 14 is in a meshing engagement with the pinion gear 8. A pair of saw blade locking members 15 are attached to the drive shaft 11. The saw blade locking members 15 are not rotatable relative to the drive shaft 11 and pinch the saw blade 4 therebetween.

The portable electric circular saw 1 further includes a safety cover 16 pivotably supported by the drive shaft 11. The safety cover 16 is adapted to cover substantially a lower half of the outer periphery of the saw blade 4 and can be retracted into the saw cover 5. The safety cover 16 has a lever 16a for manual pivotal movement operation. The safety cover 16 is urged by an urging member (not shown), such as a spring. FIG. 1 shows the initial state of the safety cover 16, where the most part of the safety cover 16 projects downward beyond the bottom surface 6a of the base 6 so as to prevent the outer periphery of the saw blade 4 from being exposed. When a cutting operation is conducted, the front end of the safety cover 16 abuts the rear end of the workpiece. As the user slides the portable electric circular saw 1 on the workpiece in the cutting direction, the safety cover 16 is pivotably moved about the drive shaft 11 and enters the saw cover 5 against the urging force of the urging member, exposing the saw blade 4 at the bottom surface 6a side of the base 6.

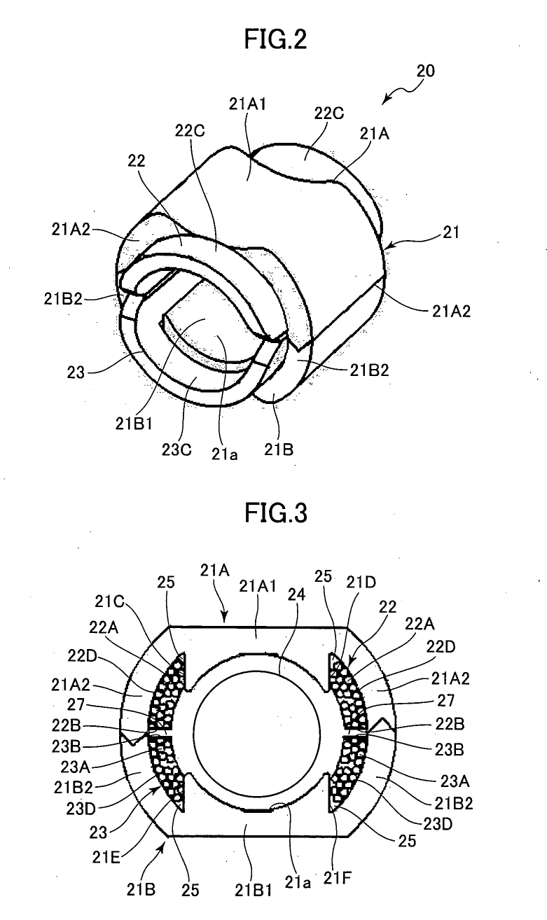

Next, the motor 20 will be described with reference to FIG. 2 and FIG. 3. The motor 20 includes a stator core 21, the first molded coil 22, the second molded coil 23, and the rotor 24 (see FIG. 1). The rotor 24 has been omitted from FIG. 2. The stator core 21 is supported and fixed by a plurality of ribs (not shown) in the housing 2 and includes a first stator core 21A and a second stator core 21B opposing the first stator core 21A.

The first stator core 21A includes a first coil mounting portion 21A1 and a pair of first stator core legs 21A2. The first molded coil 22 is mounted on the first coil mounting portion 21A1. The pair of first stator core legs 21A2 extend from both ends of the first coil mounting portion 21A1 in the circumferential direction of the rotor 24 and along the outer periphery of the rotor 24. Similarly, the second stator core 21B includes a second coil mounting portion 21B1 and a pair of second stator core legs 21B2. Free ends of the first stator core legs 21A2 fit into free ends of the second stator core legs 21B2 opposing the first stator core legs 21A2, thereby forming a hollow area 21a into which the rotor 24 is loosely inserted.

The first coil mounting portion 21A1 includes a first contact surface 21C and a second contact surface 21D those extending along the axis of the rotor 24 substantially parallel to each other for contacting and supporting a pair of first axial portions 22D of the first molded coil 22 described later. Similarly, the second coil mounting portion 21B1 includes a third contact surface 21E and a fourth contact surface 21F those substantially parallel to each other for contacting and supporting a pair of second axial portions 23D of the second molded coil 23 described later. Here, the first contact surface 21C and third contact surface 21E are positioned substantially in an identical plane, and the second contact surface 21D and fourth contact surface 21F are also positioned substantially in an identical plane.

The first molded coil 22 has a first coil 22A that is entirely covered with a thermosetting resin 25 that is electrically insulating and has high thermal conductivity, such as a vinylester resin with alumina filler. The first coil 22A and the first stator core 21A are integrally firmly fixed by the thermosetting resin 25 which is injected in a metal mold (not shown) to cover the entire first coil 22A after the first stator core 21A and the first coil 22A mounted on the first coil mounting portion 21A1 are fixed to the metal mold. Similarly, the second molded coil 23 includes a second coil 23A entirely covered with the thermosetting resin 25. The second coil 23A and the second stator core 21B are integrally firmly fixed by the thermosetting resin 25. The first molded coil 22 includes a pair of first circumferential portions 22C, and the pair of first axial portions 22D. The second molded coil 23 also includes a pair of second circumferential portions 23C, and the pair of second axial portions 23D. The pairs of first and second circumferential portions 22C and 23C project outward from both axial ends of the stator core 21 (see FIG. 2), and are roughly arc-shaped along the periphery of the rotor 24, respectively. The pairs of the first and second axial portions 22D and 23D extend inside the stator core 21 in the axial direction of the rotor 24, respectively. The first axial portion 22D includes a pair of first coil surface 22B that extends in the axial direction of the rotor 24. The second axial portion 23D includes a pair of second coil surface 23B that opposes the pair of first coil surface 22B.

The pairs of first circumferential portions 22C and first axial portions 22D form a substantially rectangular shape, and are mounted around the first coil mounting portion 21A1. Similarly, the pairs of second circumferential portions 23C and second axial portions 23D form a substantially rectangular shape, and are mounted around the second coil mounting portion 21B1. Air paths 27 through which fan airflow can pass are provided between one of the first coil surface 22B and the opposing second coil surface 23B, and between the remaining one of the first coil surface 22B and the opposing second coil surface 23B.

Next, operation of the portable electric circular saw 1 will be described. When a switch (not shown) on the circular saw 1 is turned to the ON position, a power supply (not shown) supplies an electric current to the first and second coils 22A and 23A and the rotor 24. The current generates a magnetic field between the first coil 22A and second coil 23A. The magnetic field and the current flowing through the rotor 24 generate a force that rotates the rotor 24. Rotations of the rotor 24 cause the output shaft 26 to rotate, and the rotational force of the output shaft 26 is transferred to the saw blade 4 via the pinion gear 8, gear 14, drive shaft 11, and saw blade locking members 15, whereby the saw blade 4 rotates in a normal direction for performing a cutting operation.

During the cutting operation, the rotations of the output shaft 26 also rotate the fan 7. The rotating fan 7 draws air into the housing 2 via the air inlet 2a. The air passes through the air paths 27 and cools the first and second molded coils 22 and 23 in which heat is generated by the flowing current. The fan airflow flows in the radial direction of the fan 7 and in the axial direction of the rotor 24, and is discharged from the fan airflow outlet 5a.

By providing the air path 27, the area of the surface that dissipates heat generated in the first and second molded coils 22 and 23 is increased in comparison with that of conventional motors. Hence, the cooling efficiency of the fan airflow increases, thereby increasing the service life of the motor 20. Further, since the first and second coil 22A, 23A and the first and second stator core 21A, 21B are integrally firmly fixed by the thermosetting resin 25, respectively, the shape of the metal mold can be simplified, thereby reducing the metal mold costs. Further, the production time and production cost of the motor 20 can be reduced.

The thermosetting resin 25 is also unlikely to deform from heat even when the motor 20 reaches high temperatures as the result of application of a large load. Since the first and second coils 22A and 23A are unlikely to deform by heat, it is possible to prevent the first and second circumferential portions 22C and 23C from deforming and coming into contact with the rotor 24, thereby improving the durability of the motor 20.

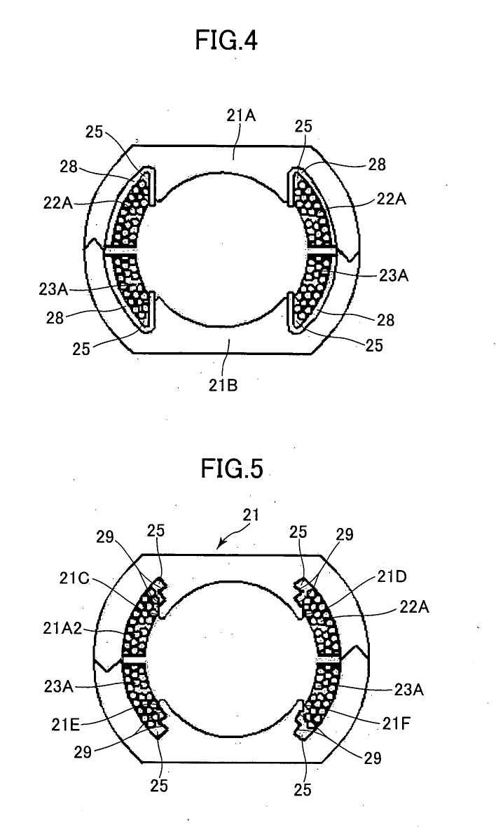

Next, a motor according to a second embodiment of the present invention will be described with reference to FIG. 4. As shown in FIG. 4, insulating members 28 are interposed between the first and second coil 22A, 23A and the first and second stator core 21A, 21B, respectively. The insulating members 28, the first and second coil 22A, 23A and the first and second stator core 21A, 21B are integrally firmly fixed by the thermosetting resin 25. This configuration can improve the insulating capacity of the stator core 21.

FIG. 5 shows a motor according to a third embodiment of the present invention. In the third embodiment, a plurality of recesses 29 are formed in the first through fourth contact surface 21C˜21F. With this construction, the thermosetting resin 25 flows and becomes solidified in the recesses 29. Therefore, the unity of the stator core 21 and the first and second coil 22A, 23A by the thermosetting resin 25 can be strengthened.

While the invention has been described in detail with reference to specific embodiments thereof, it would be apparent to those skilled in the art that various modifications may be made therein without departing from the spirit of the invention, the scope of which is defined by the attached claims. For example, while the plurality of recesses 29 are formed in the first through fourth contact surface 21C˜21F in the third embodiment, a plurality of protrusions may be provided on the first through fourth contact surface 21C˜21F. With this construction, the unity of the stator core 21 and the first and second coil 22A, 23A by the thermosetting resin 25 can be strengthened. Further, the present invention may be applied to various tools other than the circular saw described above.

What is claimed is:

1. The electric tool comprising:
a housing defining an outer frame;
an electric motor comprising:
a stator core accommodated in and fixed to the housing, the stator core comprising a first stator core including a first coil mounting portion, and a second stator core including a second coil mounting portion, the second stator core opposing the first stator core and being separated from the first stator core, a hollow area being provided in cooperation with the first stator core and the second stator core;
a first coil mounted in the first coil mounting portion;
a second coil mounted in the second coil mounting portion and opposing the first coil; and
a rotor rotatably disposed in the hollow area and between the first coil and the second coil;
wherein the first coil and the first stator core are integrally firmly fixed to each other by a resin, and the second coil and the second stator core are integrally firmly fixed to each other by the resin.

2. The electric tool as claimed in claim 1, further comprising insulating members interposed between the first coil and the first stator core, and between the second coil and the second stator core.

3. The electric tool as claimed in claim 1, wherein one of a recess and a protrusion is formed on portions of the first stator core and the second stator core, the portions being in contact with the resin.

4. The electric tool as claimed in claim 1, wherein an air path extending in an axial direction of the stator core is formed between the first coil covered with the resin and the second coil covered with the resin.

5. The electric tool as claimed in claim 1, wherein the resin is a thermosetting resin.

6. The electric tool as claimed in claim 1, wherein the housing formed with an air inlet for intaking air, and an air outlet for exhausting air,
further comprising a fan disposed in the housing for cooling the first coil and second coil by drawing air into the housing through the air inlet and blowing the air out of the housing through the air outlet.

7. An electric motor comprising:
a stator core comprising a first stator core including a first coil mounting portion, and a second stator core including a second coil mounting portion, the second stator core opposing the first stator core and being separated from the first stator core, a hollow area being provided in cooperation with the first stator core and the second stator core;
a first coil mounted in the first coil mounting portion;
a second coil mounted in the second coil mounting portion and opposing the first coil; and
a rotor rotatably disposed in the hollow area and between the first coil and the second coil;
wherein the first coil and the first stator core are integrally firmly fixed to each other by a resin, and the second coil and the second stator core are integrally firmly fixed to each other by the resin.

8. The electric motor as claimed in claim 7, further comprising insulating members interposed between the first coil and the first stator core, and between the second coil and the second stator core.

9. The electric motor as claimed in claim 7, wherein one of a recess and a protrusion is formed on portions of the first stator core and the second stator core, the portions being in contact with the resin.

10. The electric motor as claimed in claim 7, wherein an air path extending in an axial direction of the stator core is formed between the first coil covered with the resin and the second coil covered with the resin.

11. The electric motor as claimed in claim 7, wherein the resin is a thermosetting resin.
